(19) United States
(12) Patent Application Publication
(10) Pub. No.: US 2025/0039690 A1
(43) Pub. Date: Jan. 30, 2025

(54) REPORT OF NOISE PREDICTION IN BANDWIDTH REGIONS

(71) Applicant: QUALCOMM Incorporated, San Diego, CA (US)

(72) Inventors: Aviv REGEV, Tel Aviv (IL); Ronen SHAKED, Kfar Saba (IL); Shay LANDIS, Hod Hasharon (IL)

(21) Appl. No.: 18/360,526

(22) Filed: Jul. 27, 2023

(51) Int. Cl. H04W 24/02; H04W 24/08

(52) U.S. Cl. CPC H04W 24/02; H04W 24/08

(57) ABSTRACT

Various aspects of the present disclosure generally relate to wireless communication. In some aspects, a user equipment (UE) may transmit information indicating predicted noise information associated with a plurality of bandwidth regions. The UE may receive a communication configuration associated with the plurality of bandwidth regions. The UE may perform a communication in accordance with the communication configuration. Numerous other aspects are described.

### FIELD OF THE DISCLOSURE

Aspects of the present disclosure generally relate to wireless communication and to techniques and apparatuses for reporting of a noise prediction in bandwidth regions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a power spectrum density (PSD) on bandwidth regions of a communicating bandwidth, in accordance with the present disclosure.

FIG. 5 is a diagram illustrating an example of signaling associated with reporting of predicted noise information, in accordance with the present disclosure.

FIG. 6 is a diagram illustrating a correlation or autocovariance of a predicted cross-cell interference value at a time t for various Doppler values.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### SUMMARY

Some aspects described herein relate to a method of wireless communication performed by a user equipment (UE). The method may include transmitting information indicating predicted noise information associated with a plurality of bandwidth regions. The method may include receiving a communication configuration associated with the plurality of bandwidth regions. The method may include performing a communication in accordance with the communication configuration.

Some aspects described herein relate to a method of wireless communication performed by a network node. The method may include receiving information indicating predicted noise information associated with a plurality of bandwidth regions of a cell. The method may include transmitting a communication configuration associated with the plurality of bandwidth regions. The method may include performing a communication in accordance with the communication configuration.

Some aspects described herein relate to an apparatus for wireless communication at a UE. The apparatus may include one or more memories and one or more processors coupled to the one or more memories. The one or more processors may be configured to transmit information indicating predicted noise information associated with a plurality of bandwidth regions. The one or more processors may be configured to receive a communication configuration associated with the plurality of bandwidth regions. The one or more processors may be configured to perform a communication in accordance with the communication configuration.

Some aspects described herein relate to an apparatus for wireless communication at a network node. The apparatus may include one or more memories and one or more processors coupled to the one or more memories. The one or more processors may be configured to receive information indicating predicted noise information associated with a plurality of bandwidth regions of a cell. The one or more processors may be configured to transmit a communication configuration associated with the plurality of bandwidth regions. The one or more processors may be configured to perform a communication in accordance with the communication configuration.

Some aspects described herein relate to a non-transitory computer-readable medium that stores a set of instructions for wireless communication by a UE. The set of instructions, when executed by one or more processors of the UE, may cause the UE to transmit information indicating predicted noise information associated with a plurality of bandwidth regions. The set of instructions, when executed by one or more processors of the UE, may cause the UE to receive a communication configuration associated with the plurality of bandwidth regions. The set of instructions, when executed by one or more processors of the UE, may cause the UE to perform a communication in accordance with the communication configuration.

Some aspects described herein relate to a non-transitory computer-readable medium that stores a set of instructions for wireless communication by a network node. The set of instructions, when executed by one or more processors of the network node, may cause the network node to receive information indicating predicted noise information associated with a plurality of bandwidth regions of a cell. The set of instructions, when executed by one or more processors of the network node, may cause the network node to transmit a communication configuration associated with the plurality of bandwidth regions. The set of instructions, when executed by one or more processors of the network node, may cause the network node to perform a communication in accordance with the communication configuration.

Some aspects described herein relate to an apparatus for wireless communication. The apparatus may include means for transmitting information indicating predicted noise information associated with a plurality of bandwidth regions. The apparatus may include means for receiving a communication configuration associated with the plurality of bandwidth regions. The apparatus may include means for performing a communication in accordance with the communication configuration.

Some aspects described herein relate to an apparatus for wireless communication. The apparatus may include means for receiving information indicating predicted noise information associated with a plurality of bandwidth regions of a cell. The apparatus may include means for transmitting a communication configuration associated with the plurality of bandwidth regions. The apparatus may include means for performing a communication in accordance with the communication configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

A wireless network such as a radio access network (RAN) may include a number of network nodes, such as gNBs. The network nodes may provide access to the wireless network via cells. A user equipment (UE) may connect to a cell in order to access the wireless network via the network node.

A network node may allocate different frequency and time resources to each UE served by the network node, which reduces the occurrence of interference between downlink transmissions by the network node to different UEs. However, in some examples, different network nodes may provide overlapping resources (such as the same frequency and time resources) to different UEs. For example, different cells may use the same time and frequency resources. Ideally, the overlapping resources do not cause inter-cell interference since the different cells may cover different geographic areas, and since a UE associated with a first cell may be sufficiently far from a network node providing a second cell such that the second cell's transmission attenuate to the point of causing, at most, acceptable interference.

However, in some examples, inter-cell interference may occur between network nodes. For example, the UE's downlink detection of a signal transmitted by a first network node may be compromised by a downlink transmission of a second network node. Wireless networks are expected to become denser over time, including an increased density of network nodes and an increased number of UEs served by the wireless networks. Thus, the distance between network nodes may decrease, as may the average distance between UEs served by network nodes. This increase in density may increase the amount of noise, such as inter-cell interference, in the system.

A wireless communication device may use a communication configuration to transmit or receive communications. For example, the communication configuration may indicate a modulation and coding scheme (MCS). An MCS can be characterized by a complexity, in which a less complex MCS provides lower data rates with higher reliability and robustness whereas a more complex MCS provides higher data rates at the cost of lower reliability. For example, a more complex MCS (such as 4K quadrature amplitude modulation (QAM) or 16K QAM) may benefit from, or may only be usable in, conditions with a high signal-to-interference-plus-noise ratio (SINR) as compared to a less complex MCS.

In some situations, the amount of noise may vary across an operating bandwidth of a UE or a network node. For example, a UE may communicate on an operating bandwidth, such as a carrier, a bandwidth part, a group of subcarriers, or a resource allocation. A first bandwidth region of the operating bandwidth may be associated with a first noise level (e.g., a first SINR, a first interference level, or the like), and a second bandwidth region of the operating bandwidth may be associated with a second noise level different than the first noise level. Therefore, a communication configuration that indicates a single parameter (e.g., a single MCS) for an entire operating bandwidth may lead to a situation where the single parameter is suitable in the first bandwidth region and not in the second bandwidth region. For example, an MCS indicated by the communication configuration may be usable in the first bandwidth region and not in the second bandwidth region.

Furthermore, configuration of the communication configuration according to historical information may be suboptimal in some scenarios. For example, a channel in a first deployment may change rapidly, whereas a channel in a second deployment may remain coherent for a longer period of time than the channel in the first deployment. Relying on reporting of historical information regarding noise in the channel, particularly at the bandwidth region granularity, may lead to configuration or scheduling by the network that does not take into account current conditions.

Various aspects relate generally to reporting of channel conditions such as a noise level. Some aspects more specifically relate to reporting of a predicted noise level at the granularity of a bandwidth region. In some examples, a UE may transmit information indicating predicted noise information associated with a plurality of bandwidth regions. For example, the predicted noise information may include a plurality of predicted noise values that each correspond to a different bandwidth region. The UE may receive a communication configuration associated with the plurality of bandwidth regions. For example, the communication configuration may indicate a first MCS for a first bandwidth region and a second MCS for a second bandwidth region.

Particular aspects of the subject matter described in this disclosure can be implemented to realize one or more of the following potential advantages. In some examples, by providing predicted noise information for a plurality of bandwidth regions, the described techniques can be used to improve the richness of noise information, thereby increasing the effectiveness of communication configurations. By providing predicted noise information, the described techniques can be used to improve applicability of a communication configuration relative to determining a communication configuration using only historical or current data. By configuring a communication configuration associated with a plurality of bandwidth regions (e.g., including different MCSs for different bandwidth regions, in one example), the data rate can be improved in bandwidth regions that can support more complex communication configurations, and reliability is improved in bandwidth regions that are associated with a higher level of noise.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

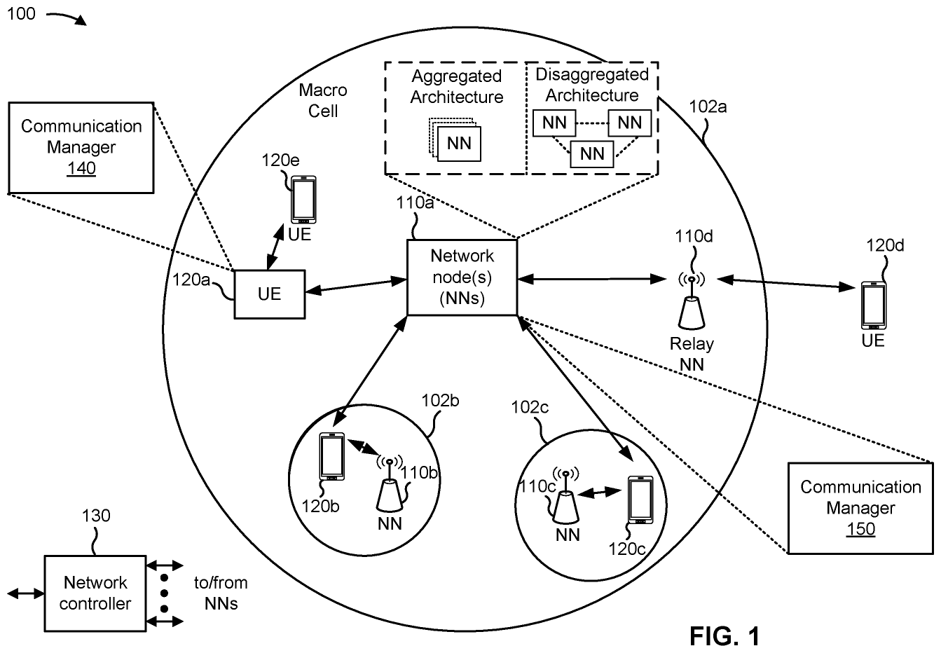

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 May include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit information indicating predicted noise information associated with a plurality of bandwidth regions; receive a communication configuration associated with the plurality of bandwidth regions; and perform a communication in accordance with the communication configuration. Additionally, or alternatively, the communication manager 140 may perform one or more other operations described herein.

In some aspects, the network node 110 may include a communication manager 150. As described in more detail elsewhere herein, the communication manager 150 may receive information indicating predicted noise information associated with a plurality of bandwidth regions of a cell; transmit a communication configuration associated with the plurality of bandwidth regions; and perform a communication in accordance with the communication configuration. Additionally, or alternatively, the communication manager 150 may perform one or more other operations described herein.

As indicated above, FIG. 1 is provided as an example. Other examples may differ from what is described with regard to FIG. 1.

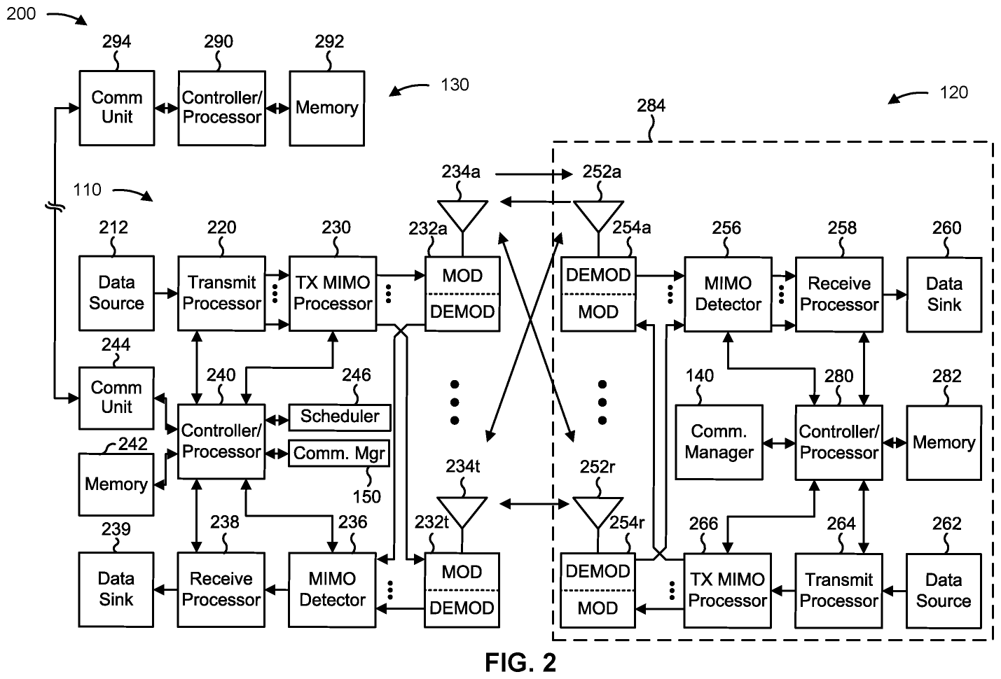

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more MCSs for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

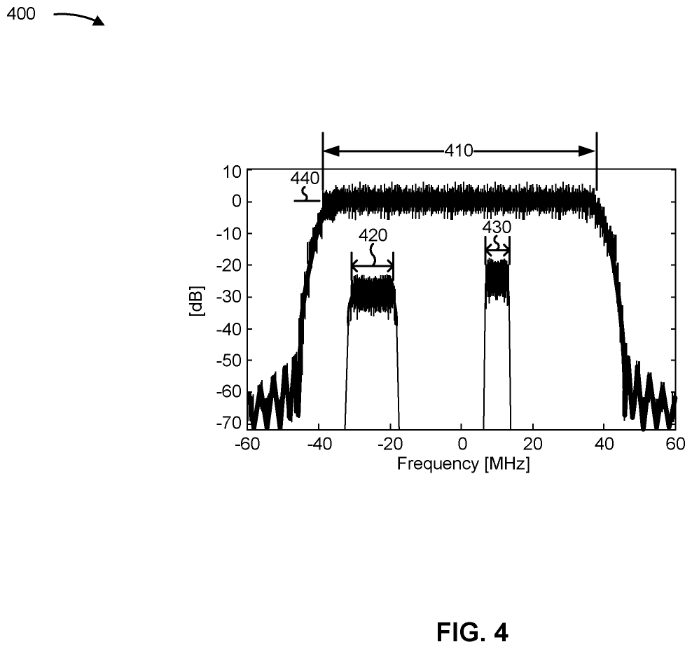

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

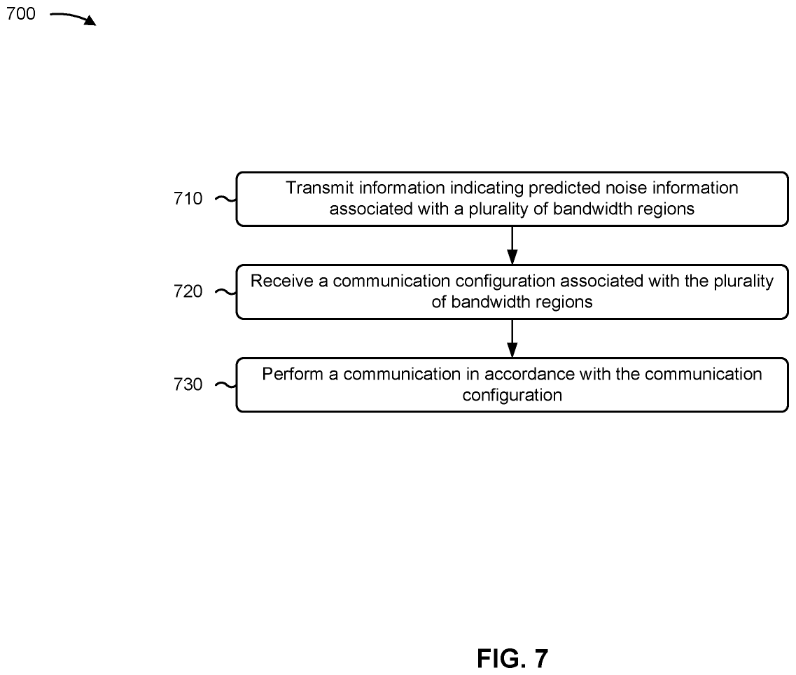

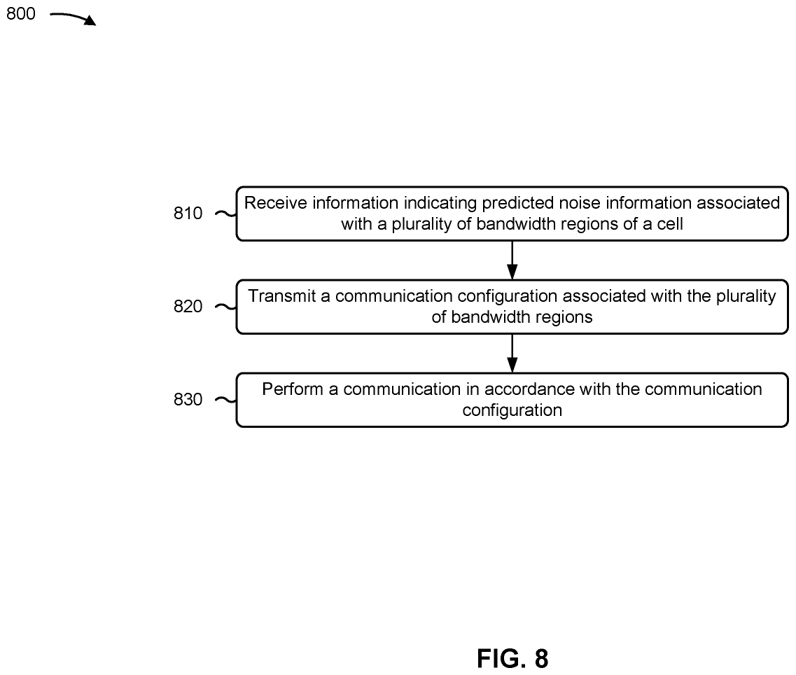

The controller/processor 240 of the network node 110, the controller/processor 280 of the UE 120, and/or any other component(s) of FIG. 2 may perform one or more techniques associated with communication configuration, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for transmitting information indicating predicted noise information associated with a plurality of bandwidth regions; means for receiving a communication configuration associated with the plurality of bandwidth regions; and/or means for performing a communication in accordance with the communication configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving information indicating predicted noise information associated with a plurality of bandwidth regions of a cell; means for transmitting a communication configuration associated with the plurality of bandwidth regions; and/or means for performing a communication in accordance with the communication configuration. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

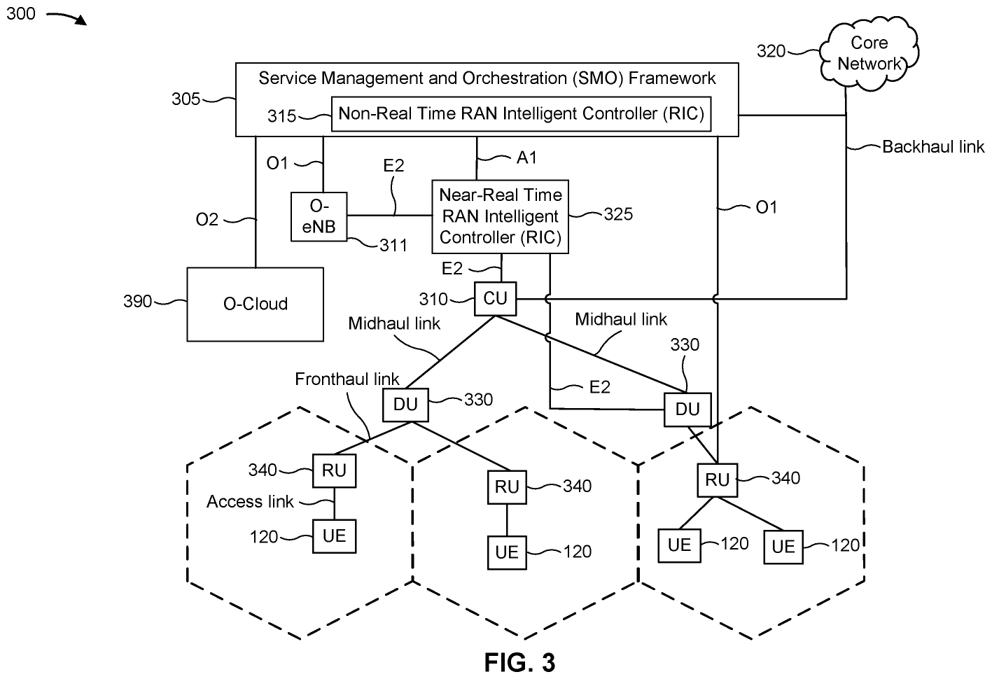

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of a power spectrum density (PSD) on bandwidth regions of a communicating bandwidth, in accordance with the present disclosure. Example 400 includes a communicating bandwidth 410, a bandwidth region 420, and a bandwidth region 430. The communicating bandwidth 410 may include, for example, a cell or carrier, a user spectrum, a bandwidth part of a UE, or a sidelink resource pool. For example, the communicating bandwidth 410 may be used for communication by a UE (e.g., UE 120), and may be configured for or signaled to the UE 120 by a network node (e.g., network node 110). It can be seen that the communicating bandwidth 410 is approximately 80 MHz, with some degree of noise outside the communicating bandwidth 410.

A baseline noise level 440 for the communicating bandwidth 410 is shown at 0 dB. The communicating bandwidth 410 is also associated with interference in bandwidth regions 420 and 430. The interference can be associated with any source, but may be due to inter-cell interference in some cases. As shown, a first bandwidth region 420 is associated with interference of approximately −25 dB, and a second bandwidth region 430 is associated with interference of approximately −20 dB. Thus, in the first bandwidth region 420 (encompassing a bandwidth of −30 to −20 MHz), the noise floor is approximately −25 dB, and in the second bandwidth region 430 (encompassing a bandwidth of −7 to −12 MHz), the noise floor is approximately 20 dB.

Some techniques described herein provide communication configurations that are specific to bandwidth regions, such that different communication configurations can be provided for bandwidth regions with different noise floors. For example, a communication configuration may specify a modulation order. A modulation order may indicate a number of bits, N_{bits}, that can be modulated onto a subcarrier. For example, N_{bits}=10 may indicate that 10 bits can be modulated onto a subcarrier, corresponding to a 1024 quadrature amplitude modulation (1024QAM) modulation scheme. In one example, the modulation order for a bandwidth region associated with a given SINR may be defined as:

$${N}_{bits} ( S I N R ) = ( \frac{S I N R [ dB ] - TH [ dB ]}{3} )$$

where “SINR” represents a ratio of a signal strength to a sum of thermal noise and cross-cell interference in the bandwidth region, and TH is a configurable guard interval, which may be based at least in part on system needs. This may be considered a high signal-to-noise ratio (SNR) approximation of a Shannon capacity formula. In one example, communication configurations for the communicating bandwidth 410, the first bandwidth region 420, and the second bandwidth region 430 may be as shown in Table 1:

TABLE 1

| Frequency interval [MHz] | SINR [dB] | N_{bits} |
|---|---|---|
| [−30, −20] | 25 | 7 (e.g., 128 QAM) |
| [33, 33.6] | 20 | 6 (e.g., 64 QAM) |
| Otherwise | 50 | 14 (e.g., 16K QAM) |

In this example, a network node may signal, to a UE, one or more communication configurations that indicate the modulation orders for the communicating bandwidth 410, the first bandwidth region 420, and the second bandwidth region 430. For example, a first communication configuration may indicate the modulation order for the communicating bandwidth 410, a second communication configuration may indicate the modulation order for the first bandwidth region 420, and a third communication configuration may indicate the modulation order for the second bandwidth region 430. As another example, a single communication configuration may indicate modulation orders for each of the communicating bandwidth 410, the first bandwidth region 420, and the second bandwidth region 430. Some techniques described herein provide prediction of noise information (such as an SINR, a noise floor, a noise level, or the like) for a bandwidth region, and/or signaling to support reporting of predicted noise information and/or a communication configuration based at least in part on noise information such as predicted noise information. By providing communication configurations (or modulation orders) specific to bandwidth regions (such as bandwidth regions 420 and 430) that are proper subsets of a communicating bandwidth 410, bandwidth may be utilized more efficiently than a fixed modulation order across the entire communicating bandwidth 410. For example, higher-order modulation can be used in bandwidth regions having a higher SINR, and lower-order modulation can be used in bandwidth regions having a lower SINR. In this way, the UE may avoid failure to demodulate higher-order modulation in regions that are impaired by interference, and can utilize capacity in bandwidth regions having a higher SINR.

As indicated above, FIG. 4 is provided as an example. Other examples may differ from what is described with regard to FIG. 4.

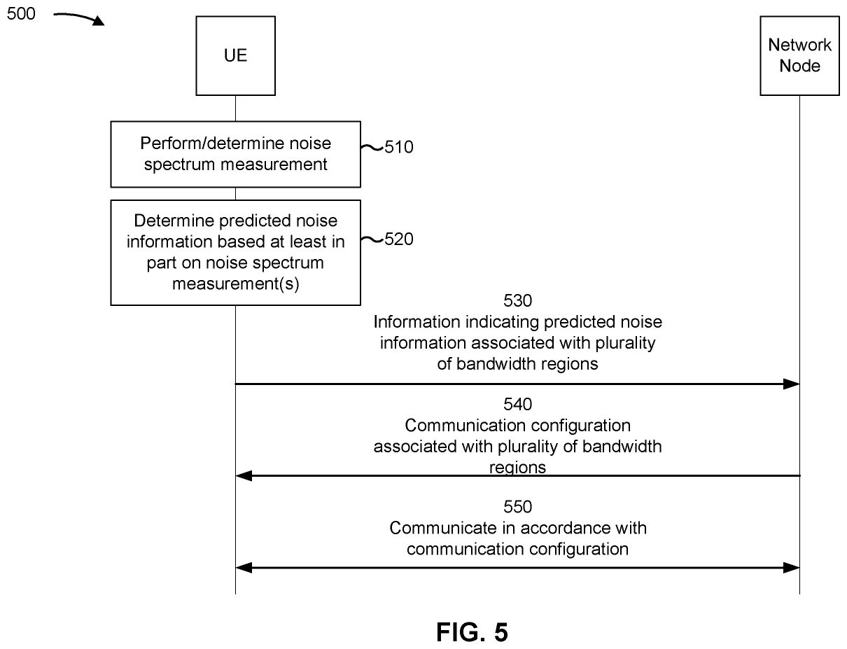

FIG. 5 is a diagram illustrating an example 500 of signaling associated with reporting of predicted noise information, in accordance with the present disclosure. Example 500 includes a UE (e.g., UE 120) and a network node (e.g., network node 110). In some aspects, the UE may be associated with a communicating bandwidth (e.g., communicating bandwidth 410, such as a cell, a bandwidth part, a resource pool, or the like). For example, the network node may transmit configuration information configuring the cell for the UE. In some aspects, the network node may be associated with the communicating bandwidth. For example, the network node may communicate with one or more UEs on the communicating bandwidth. In some aspects, the UE may be associated with one or more bandwidth regions (e.g., bandwidth region 420, bandwidth region 430, a bandwidth part of a cell, a resource pool, a configured bandwidth region for measurement) of the communicating bandwidth. For example, a bandwidth region may consist of a proper subset of a communicating bandwidth.

As shown in FIG. 5, and by reference number 510, the UE may determine a noise spectrum measurement. In some aspects, the UE may determine the noise spectrum measurement using a channel estimation, as described below. In some aspects, the noise spectrum measurement may be based at least in part on an estimation of noise spectrum from a previous time resource (e.g., a previous slot). For example, the UE may estimate the channel in each slot based at least in part on a received signal. The received signal, as a function of a frequency index k, can be expressed as yₖ=Hₖxₖ+nₖ, where yₖ is the received signal, Hₖ is the propagation channel (expressed as a channel matrix), xₖ is a signal transmitted via the propagation channel, and nₖ is a noise value. The UE may estimate the channel in a slot, where the estimated channel is represented by Ĥ. The UE may determine a noise spectrum value \hat{n}ₖ for a given slot and/or bandwidth region as \hat{n}ₖ=yₖ−Ĥₖxₖ. The UE may use the noise spectrum value \hat{n}ₖ, in addition to or as an alternative to one or more noise spectrum value of previous slots, to determine predicted noise information, as described elsewhere herein.

In some other aspects, the UE may determine the noise spectrum measurement according to a measurement configuration. The UE may receive the measurement configuration from the network node or from another network node. The measurement configuration may indicate one or more parameters for measurement, such as a resource (e.g., a bandwidth region) on which to perform the measurement, a type of measurement to perform (e.g., SINR, RSRP, RSRQ, etc.), a periodicity associated with the measurement, a reporting threshold based on which to report predicted noise information or measurement information derived from the noise spectrum measurement, or the like. In some aspects, the measurement configuration may be included in or associated with (or may be received separately from without being associated with) a configuration for reporting predicted noise information. The configuration for reporting predicted noise information may indicate one or more parameters used to determine and/or report predicted noise information, such as a technique for determining the predicted noise information, a length of a time window of the prediction, parameters of a model used to determine the predicted noise information, reporting parameters for the predicted noise information, or the like.

The noise spectrum measurement may include any suitable measurement, such as an RSRP measurement, an RSRQ measurement, an SNR measurement, an SINR measurement, or the like. In some aspects, the noise spectrum measurement may indicate a sum of a thermal noise value (sometimes referred to as Johnson-Nyquist noise) and a cross-cell interference value. Cross-cell interference may include interference (e.g., received signal power) from a cell other than a serving cell of the UE. For example, cross-cell interference may be a result of downlink transmission from the network node or from another network node. In some aspects, the UE may perform the noise spectrum measurement by determining a measurement value (e.g., RSRP, RSRQ. SINR. SNR) regarding a reference signal. In some aspects, the UE may perform the noise spectrum measurement by determining a measurement value (e.g., RSRP, RSRQ. SINR, SNR) regarding a resource. For example, the reference signal may be transmitted in the resource. The measurement configuration may indicate the reference signal and/or the resource.

As shown by reference number 520, the UE may determine predicted noise information based at least in part on the noise spectrum measurement. For example, the UE may estimate a predicted noise value (e.g., a predicted SINR) for one or more bandwidth regions. The UE may determine the predicted noise information using any suitable technique. For example, in some aspects, the UE may determine the predicted noise information using a machine learning model trained using a machine learning algorithm. The machine learning model may be trained using a dataset of noise spectrum measurements and corresponding noise information. For example, the dataset may include a noise spectrum measurement and noise information for a time window that follows a time associated with the noise spectrum measurement, such that the machine learning model is trained to output predicted noise information based on an input of a noise spectrum measurement.

In some aspects, the UE may determine the predicted noise information using a statistical approach. For example, the UE may use a predictor, based at least in part on the noise spectrum measurement, to determine a predicted cross-cell interference for one or more bandwidth regions, and may determine the predicted noise information using the cross-cell interference. The UE may predict a cross-cell interference value by characterizing a sum of the cross-cell interference and the thermal noise as a random process i(t). The UE may use an autocovariance (e.g., correlation) function of the random process i(t) to determine predicted noise information. The autocovariance function may indicate a predicted cross-cell interference at a future time (1+T) using an input of a spectrum noise measurement at a time t. Thus, t (tau) may represent a length of a time window of the predicted noise information. The UE may use noise spectrum measurements from one or more slots, such as one or more previous slots, to determine a predicted cross-cell interference for a bandwidth region. For example, the noise spectrum measurements may include FFT samples of the random process i(t). In some aspects, the UE may determine the predicted noise information for one or more future slots, such as one or more downlink slots (e.g., next downlink slots). In some aspects, the noise spectrum measurements from the one or more slots may be based at least in part on a time window for the predicted noise information. For example, the UE may use, as input to a model or predictor, noise spectrum measurements from a historical time window equal in length to, or based at least in part on a length of, the time window for the predicted noise information.

In some aspects, the UE may determine the predicted noise information based at least in part on an autoregressive-moving-average (ARMA) model. For example, the UE may predict the cross-cell interference according to i(1+τ) on the assumption that i(t) is an ARMA process.

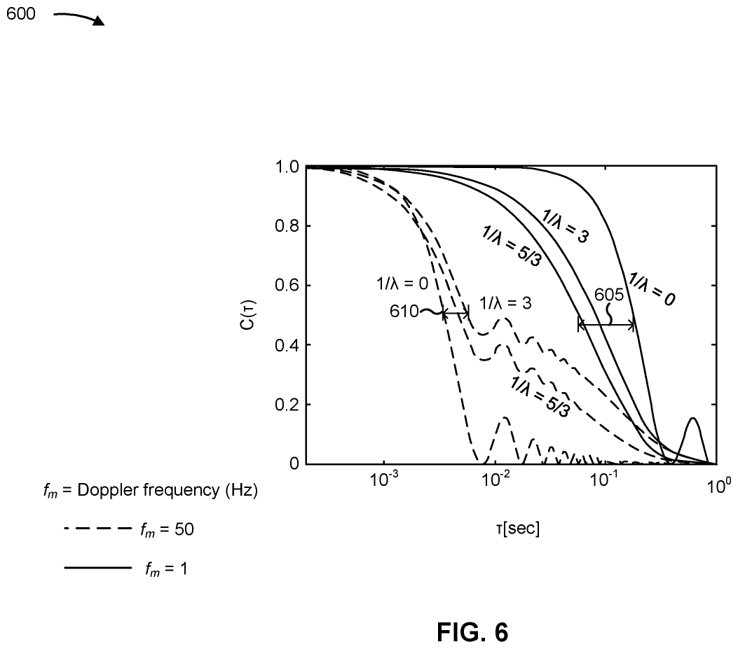

In some aspects, the predicted noise information may be based at least in part on a Doppler effect. For example, a UE associated with a higher Doppler effect (indicating a larger frequency shift due to movement of the UE, the network node, or both) may use a shorter time window (a smaller value of τ) than a UE associated with a lower Doppler effect (indicating a smaller frequency shift). FIG. 6 is a diagram illustrating a correlation or autocovariance (C(τ)) of a predicted cross-cell interference value at a time t for various Doppler values. The dashed lines indicate correlation or autocovariance corresponding to a Doppler shift of 50 Hz. The solid lines indicate correlation or autocovariance corresponding to a Doppler shift of 1 Hz. Thus, dashed lines generally illustrate correlation or autocovariance at high Doppler shift, whereas solid lines generally illustrate correlation or autocovariance at low Doppler shift. In FIG. 6, interference on the channel is modeled in a series of on and off states, which is a common model for the on-off behavior of calls in a cellular channel. The time intervals spent in on and off states may be modeled as independent and exponentially distributed random variables with an expectation of

$$\frac{1}{λ} = \{ 0 , \frac{5}{3} , 3 \} , \frac{1}{μ} = 1 [ in seconds ] .$$

It can be seen at reference number 605 that, given the above parameters and low Doppler shift (e.g., solid lines), the predicted cross-cell interference (and thus the predicted noise information) may satisfy a threshold of 0.5 at approximately 10-1.5 seconds to 10-0.9 seconds, corresponding to a range of approximately 31 ms to 125 ms, respectively. It can be seen at reference number 610 that, given the above parameters and high Doppler shift (e.g., solid lines), the predicted cross-cell interference (and thus the predicted noise information) may satisfy a threshold of 0.5 at approximately 10-2.75 seconds to 10-1.85 seconds, corresponding to a range of approximately 1.7 ms to 14 ms. These time values can be converted into numbers of slots according to a numerology or sub-carrier spacing of the communicating bandwidth. For example, a numerology of 1 may correspond to 10 slots in a 5 ms window or 1000 slots in a 500 ms window, and a numerology of 6 may correspond to 320 slots in a 5 ms window or 32000 slots in a 500 ms window. The above time intervals and predicted cross-cell interference are provided as examples. In some examples, the UE may provide predicted noise information corresponding to a time window within one of the above ranges (e.g., a time window of 5 ms). In some examples, the UE may provide predicted noise information corresponding to a time window that is not within one of the above ranges (e.g., a time window of 500 ms).

In some examples, the time window for the predicted noise information may be based at least in part on a Doppler value associated with a communicating bandwidth or a bandwidth region. For example, if the Doppler value for a bandwidth region fails to satisfy a threshold (e.g., is lower than the threshold), the UE may use a shorter time window for the predicted noise information for the bandwidth region (e.g., 5 ms), and if the Doppler value satisfies the threshold (e.g., is higher than or equal to the threshold), the UE may use a longer time window for the predicted noise information (e.g., 500 ms). As another example, if a correlation time of the UE (which may be based at least in part on the Doppler value) fails to satisfy a threshold (e.g., is shorter than the threshold), the UE may use a shorter time window for the predicted noise information, and if the correlation time satisfies the threshold (e.g., is longer than or equal to the threshold), the UE may use a longer time window for the predicted noise information.

Returning to FIG. 5, as shown by reference number 530, the UE may transmit, and the network node may receive, information indicating predicted noise information associated with a plurality of bandwidth regions. In some aspects, the UE may transmit the information in accordance with a periodicity. For example, the UE may transmit the information every x ms. In some aspects, x may be based at least in part on a time window for the predicted noise information. For example, if the time window is x ms in length, the UE may transmit the information every x ms. In some aspects, the predicted noise information may relate to a single bandwidth region. Additionally, or alternatively, the predicted noise information may relate to a plurality of bandwidth regions. The predicted noise information may indicate, for each bandwidth region to which the predicted noise information relates, a respective predicted noise value (which may be based at least in part on a sum of a thermal noise and a cross-cell interference value for the respective bandwidth region). For example, the predicted noise information may explicitly indicate the respective predicted noise values (e.g., an SINR for each of the bandwidth regions). As another example, the predicted noise information may indicate one or more predicted noise values via one or more offsets respective to a reference point, such as a configured reference point or another predicted noise value. In one example, for a set of bandwidth regions 1 through N_{end} (expressed in terms of subcarriers), the predicted noise information may include a table such as the below Table 2:

TABLE 2

| BW region [SCs] | Reported SINR |
|---|---|
| 1 . . . N₁ | 40 dB |
| N₁ + 1 . . . N₂ | 25 dB |
| . . . | . . . |
| N₃ + 1 . . . N_{end} | 30 dB |

In some aspects, the UE may transmit the predicted noise information via a physical uplink channel. For example, the UE may transmit the predicted noise information via a physical uplink control channel or a physical uplink shared channel. This may be beneficial in a situation where the correlation time of the channel is relatively short. For example, the UE may transmit the predicted noise information in every slot, which enables the network node to configure communications in rapidly changing channel conditions. In some other aspects, the UE may transmit the predicted noise information via a channel state information report. For example, the UE may transmit the predicted noise information via a channel state feedback report at the periodicity of a channel state information reference signal periodicity, which reduces overhead relative to transmitting in every slot.

As shown by reference number 540, the network node may transmit, and the UE may receive, a communication configuration associated with the plurality of bandwidth regions. In some aspects, the network node may transmit, and the UE may receive, a plurality of communication configurations associated with the plurality of bandwidth regions. For example, each bandwidth region may be associated with a respective communication configuration. As another example, a single communication configuration may indicate parameters for two or more bandwidth regions.

In some aspects, a communication configuration may indicate one or more parameters for communication on a bandwidth region. For example, the communication configuration may indicate a modulation order (such as via a modulation and coding scheme) for communications on the bandwidth region. The UE may transmit or receive a communication in the bandwidth region using the modulation order. In some aspects, the communication configuration may indicate different modulation orders for different frequency regions. For example, the communication configuration (or a plurality of communication configurations) may indicate a first modulation order for a first bandwidth region, a second modulation order for a second bandwidth region, and so on. In some aspects, a communication configuration may indicate a modulation order relative to a reference point. For example, the communication configuration may indicate the modulation order for a bandwidth region via an offset relative to a modulation order of a communicating bandwidth that includes the bandwidth region. Thus, the network node may configure different parameters (such as different modulation orders) for different bandwidth regions of a communicating bandwidth.

In some aspects, the communication configuration of a bandwidth region may be based at least in part on predicted noise information for the bandwidth region. For example, the network node may determine a modulation order of the bandwidth region based at least in part on predicted noise information for the bandwidth region using any suitable technique for selecting modulation orders. Generally, a lower predicted noise value (indicating lower cross-cell interference) may be associated with a higher modulation order (indicating more bits per sub-carrier) whereas a higher predicted noise value (indicating higher cross-cell interference) may be associated with a lower modulation order (indicating fewer bits per sub-carrier and more resilience to interference). As shown by reference number 550, the UE and/or the network node may perform a communication in accordance with the communication configuration. For example, the UE may transmit or decode a communication within a bandwidth region using a communication configuration (e.g., modulation order) corresponding to the bandwidth region. As another example, the UE may transmit or decode a communication within a communicating bandwidth using two or more communication configurations corresponding to two or more bandwidth regions on which the communication is transmitted or received.

As indicated above, FIGS. 5 and 6 are provided as examples. Other examples may differ from what is described with regard to FIGS. 5 and 6.

FIG. 7 is a diagram illustrating an example process 700 performed, for example, by a UE, in accordance with the present disclosure. Example process 700 is an example where the UE (e.g., UE 120) performs operations associated with reporting of noise predictions in bandwidth regions.

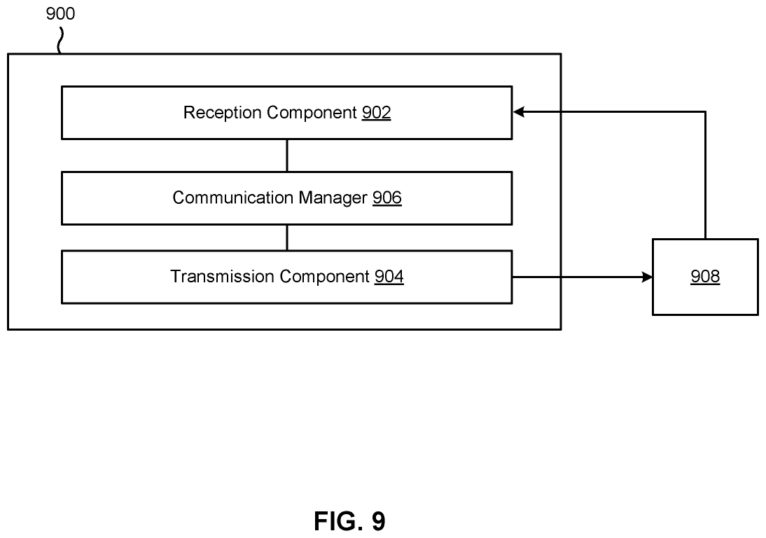

As shown in FIG. 7, in some aspects, process 700 may include transmitting information indicating predicted noise information associated with a plurality of bandwidth regions (block 710). For example, the UE (e.g., using transmission component 904 and/or communication manager 906, depicted in FIG. 9) may transmit information indicating predicted noise information associated with a plurality of bandwidth regions, as described above.

As further shown in FIG. 7, in some aspects, process 700 may include receiving a communication configuration associated with the plurality of bandwidth regions (block 720). For example, the UE (e.g., using reception component 902 and/or communication manager 906, depicted in FIG. 9) may receive a communication configuration associated with the plurality of bandwidth regions, as described above.

As further shown in FIG. 7, in some aspects, process 700 may include performing a communication in accordance with the communication configuration (block 730). For example, the UE (e.g., using communication manager 906, depicted in FIG. 9) may perform a communication in accordance with the communication configuration, as described above.

Process 700 may include additional aspects, such as any single aspect or any combination of aspects described below and/or in connection with one or more other processes described elsewhere herein.

In a first aspect, the predicted noise information includes a plurality of respective predicted noise values corresponding to the plurality of bandwidth regions.

In a second aspect, alone or in combination with the first aspect, each predicted noise value of the respective predicted noise values corresponds to a different bandwidth region of the plurality of bandwidth regions.

In a third aspect, alone or in combination with one or more of the first and second aspects, the communication configuration indicates a first modulation order for a first bandwidth region of the plurality of bandwidth regions and a second modulation order, different from the first modulation order, for a second bandwidth region of the plurality of bandwidth regions.

In a fourth aspect, alone or in combination with one or more of the first through third aspects, the first modulation order is based at least in part on a predicted noise value, of the predicted noise information, corresponding to the first bandwidth region.

In a fifth aspect, alone or in combination with one or more of the first through fourth aspects, process 700 includes performing a noise spectrum measurement, wherein the information indicating the predicted noise information is based at least in part on the noise spectrum measurement.

In a sixth aspect, alone or in combination with one or more of the first through fifth aspects, the predicted noise information is based at least in part on at least one of a thermal noise value or a cross-cell interference value.

In a seventh aspect, alone or in combination with one or more of the first through sixth aspects, the predicted noise information is based at least in part on an autocovariance function.

In an eighth aspect, alone or in combination with one or more of the first through seventh aspects, the predicted noise information is based at least in part on an autoregressive-moving-average model.

In a ninth aspect, alone or in combination with one or more of the first through eighth aspects, the predicted noise information is based at least in part on a machine learning model.

In a tenth aspect, alone or in combination with one or more of the first through ninth aspects, the predicted noise information relates to a future time interval, wherein a length of the future time interval is based at least in part on a correlation time associated with the UE.

In an eleventh aspect, alone or in combination with one or more of the first through tenth aspects, transmitting the information indicating the predicted noise information further comprises transmitting the information indicating the predicted noise information via a physical uplink channel.

In a twelfth aspect, alone or in combination with one or more of the first through eleventh aspects, transmitting the information indicating the predicted noise information further comprises transmitting the information indicating the predicted noise information via a channel state information report.

In a thirteenth aspect, alone or in combination with one or more of the first through twelfth aspects, the plurality of bandwidth regions are bandwidth regions of a cell.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with reporting of noise predictions in bandwidth regions.

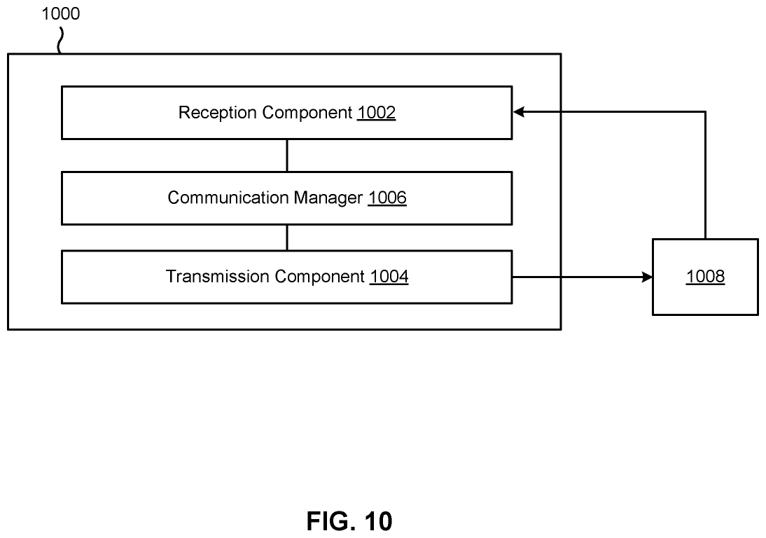

As shown in FIG. 8, in some aspects, process 800 may include receiving information indicating predicted noise information associated with a plurality of bandwidth regions of a cell (block 810). For example, the network node (e.g., using reception component 1002 and/or communication manager 1006, depicted in FIG. 10) may receive information indicating predicted noise information associated with a plurality of bandwidth regions of a cell, as described above.

As further shown in FIG. 8, in some aspects, process 800 may include transmitting a communication configuration associated with the plurality of bandwidth regions (block 820). For example, the network node (e.g., using transmission component 1004 and/or communication manager 1006, depicted in FIG. 10) May transmit a communication configuration associated with the plurality of bandwidth regions, as described above.

As further shown in FIG. 8, in some aspects, process 800 may include performing a communication in accordance with the communication configuration (block 830). For example, the network node (e.g., using communication manager 1006, depicted in FIG. 10) may perform a communication in accordance with the communication configuration, as described above.

Process 800 may include additional aspects, such as any single aspect or any combination of aspects described below and/or in connection with one or more other processes described elsewhere herein.

In a first aspect, the predicted noise information includes a plurality of respective predicted noise values corresponding to the plurality of bandwidth regions.

In a second aspect, alone or in combination with the first aspect, each predicted noise value of the respective predicted noise values corresponds to a different bandwidth region of the plurality of bandwidth regions.

In a third aspect, alone or in combination with one or more of the first and second aspects, the communication configuration indicates a first modulation order for a first bandwidth region of the plurality of bandwidth regions and a second modulation order, different from the first modulation order, for a second bandwidth region of the plurality of bandwidth regions.

In a fourth aspect, alone or in combination with one or more of the first through third aspects, the first modulation order is based at least in part on a predicted noise value, of the predicted noise information, corresponding to the first bandwidth region.

In a fifth aspect, alone or in combination with one or more of the first through fourth aspects, the information indicating the predicted noise information is based at least in part on a noise spectrum measurement.

In a sixth aspect, alone or in combination with one or more of the first through fifth aspects, the predicted noise information is based at least in part on at least one of a thermal noise value or a cross-cell interference value.

In a seventh aspect, alone or in combination with one or more of the first through sixth aspects, the predicted noise information is based at least in part on an autocovariance function.

In an eighth aspect, alone or in combination with one or more of the first through seventh aspects, the predicted noise information is based at least in part on an autoregressive-moving-average model.

In a ninth aspect, alone or in combination with one or more of the first through eighth aspects, the predicted noise information is based at least in part on a machine learning model.

In a tenth aspect, alone or in combination with one or more of the first through ninth aspects, the predicted noise information relates to a future time interval, wherein a length of the future time interval is based at least in part on a correlation time.

In an eleventh aspect, alone or in combination with one or more of the first through tenth aspects, receiving the information indicating the predicted noise information further comprises receiving the information indicating the predicted noise information via a physical uplink channel.

In a twelfth aspect, alone or in combination with one or more of the first through eleventh aspects, receiving the information indicating the predicted noise information further comprises receiving the information indicating the predicted noise information via a channel state information report.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit information indicating predicted noise information associated with a plurality of bandwidth regions. The reception component 902 may receive a communication configuration associated with the plurality of bandwidth regions. The communication manager 906 may perform a communication in accordance with the communication configuration.

The communication manager 906 may perform a noise spectrum measurement, wherein the information indicating the predicted noise information is based at least in part on the noise spectrum measurement.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 3-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive information indicating predicted noise information associated with a plurality of bandwidth regions of a cell. The transmission component 1004 may transmit a communication configuration associated with the plurality of bandwidth regions. The communication manager 1006 may perform a communication in accordance with the communication configuration.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting information indicating predicted noise information associated with a plurality of bandwidth regions; receiving a communication configuration associated with the plurality of bandwidth regions; and performing a communication in accordance with the communication configuration.

Aspect 2: The method of Aspect 1, wherein the predicted noise information includes a plurality of respective predicted noise values corresponding to the plurality of bandwidth regions.

Aspect 3: The method of Aspect 2, wherein each predicted noise value of the respective predicted noise values corresponds to a different bandwidth region of the plurality of bandwidth regions.

Aspect 4: The method of any of Aspects 1-3, wherein the communication configuration indicates a first modulation order for a first bandwidth region of the plurality of bandwidth regions and a second modulation order, different from the first modulation order, for a second bandwidth region of the plurality of bandwidth regions.

Aspect 5: The method of Aspect 4, wherein the first modulation order is based at least in part on a predicted noise value, of the predicted noise information, corresponding to the first bandwidth region.

Aspect 6: The method of any of Aspects 1-5, further comprising performing a noise spectrum measurement, wherein the information indicating the predicted noise information is based at least in part on the noise spectrum measurement.

Aspect 7: The method of any of Aspects 1-6, wherein the predicted noise information is based at least in part on at least one of a thermal noise value or a cross-cell interference value.

Aspect 8: The method of any of Aspects 1-7, wherein the predicted noise information is based at least in part on an autocovariance function.

Aspect 9: The method of any of Aspects 1-8, wherein the predicted noise information is based at least in part on an autoregressive-moving-average model.

Aspect 10: The method of any of Aspects 1-9, wherein the predicted noise information is based at least in part on a machine learning model.

Aspect 11: The method of any of Aspects 1-10, wherein the predicted noise information relates to a future time interval, wherein a length of the future time interval is based at least in part on a correlation time associated with the UE.

Aspect 12: The method of any of Aspects 1-11, wherein transmitting the information indicating the predicted noise information further comprises transmitting the information indicating the predicted noise information via a physical uplink channel.

Aspect 13: The method of any of Aspects 1-12, wherein transmitting the information indicating the predicted noise information further comprises transmitting the information indicating the predicted noise information via a channel state information report.

Aspect 14: The method of any of Aspects 1-13, wherein the plurality of bandwidth regions are bandwidth regions of a cell.

Aspect 15: A method of wireless communication performed by a network node, comprising: receiving information indicating predicted noise information associated with a plurality of bandwidth regions of a cell; transmitting a communication configuration associated with the plurality of bandwidth regions; and performing a communication in accordance with the communication configuration.

Aspect 16: The method of Aspect 15, wherein the predicted noise information includes a plurality of respective predicted noise values corresponding to the plurality of bandwidth regions.

Aspect 17: The method of Aspect 16, wherein each predicted noise value of the respective predicted noise values corresponds to a different bandwidth region of the plurality of bandwidth regions.

Aspect 18: The method of any of Aspects 15-17, wherein the communication configuration indicates a first modulation order for a first bandwidth region of the plurality of bandwidth regions and a second modulation order, different from the first modulation order, for a second bandwidth region of the plurality of bandwidth regions.

Aspect 19: The method of Aspect 18, wherein the first modulation order is based at least in part on a predicted noise value, of the predicted noise information, corresponding to the first bandwidth region.

Aspect 20: The method of any of Aspects 15-19, wherein the information indicating the predicted noise information is based at least in part on a noise spectrum measurement.

Aspect 21: The method of any of Aspects 15-20, wherein the predicted noise information is based at least in part on at least one of a thermal noise value or a cross-cell interference value.

Aspect 22: The method of any of Aspects 15-21, wherein the predicted noise information is based at least in part on an autocovariance function.

Aspect 23: The method of any of Aspects 15-22, wherein the predicted noise information is based at least in part on an autoregressive-moving-average model.

Aspect 24: The method of any of Aspects 15-23, wherein the predicted noise information is based at least in part on a machine learning model.

Aspect 25: The method of any of Aspects 15-24, wherein the predicted noise information relates to a future time interval, wherein a length of the future time interval is based at least in part on a correlation time.

Aspect 26: The method of any of Aspects 15-25, wherein receiving the information indicating the predicted noise information further comprises receiving the information indicating the predicted noise information via a physical uplink channel.

Aspect 27: The method of any of Aspects 15-26, wherein receiving the information indicating the predicted noise information further comprises receiving the information indicating the predicted noise information via a channel state information report.

Aspect 28: An apparatus for wireless communication at a device, comprising a processor; memory coupled with the processor; and instructions stored in the memory and executable by the processor to cause the apparatus to perform the method of one or more of Aspects 1-27.

Aspect 29: A device for wireless communication, comprising a memory and one or more processors coupled to the memory, the one or more processors configured to perform the method of one or more of Aspects 1-27.

Aspect 30: An apparatus for wireless communication, comprising at least one means for performing the method of one or more of Aspects 1-27.

Aspect 31: A non-transitory computer-readable medium storing code for wireless communication, the code comprising instructions executable by a processor to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to cause the UE to:
transmit information indicating predicted noise information associated with a plurality of bandwidth regions;
receive a communication configuration associated with the plurality of bandwidth regions; and
perform a communication in accordance with the communication configuration.

2. The apparatus of claim 1, wherein the predicted noise information includes a plurality of respective predicted noise values corresponding to the plurality of bandwidth regions.

3. The apparatus of claim 2, wherein each predicted noise value of the plurality of respective predicted noise values corresponds to a different bandwidth region of the plurality of bandwidth regions.

4. The apparatus of claim 1, wherein the communication configuration indicates a first modulation order for a first bandwidth region of the plurality of bandwidth regions and a second modulation order, different from the first modulation order, for a second bandwidth region of the plurality of bandwidth regions.

5. The apparatus of claim 4, wherein the first modulation order is based at least in part on a predicted noise value, of the predicted noise information, corresponding to the first bandwidth region.

6. The apparatus of claim 1, wherein the one or more processors are further configured to cause the UE to perform a noise spectrum measurement, wherein the information indicating the predicted noise information is based at least in part on the noise spectrum measurement.

7. The apparatus of claim 1, wherein the predicted noise information is based at least in part on at least one of a thermal noise value or a cross-cell interference value.

8. The apparatus of claim 1, wherein the predicted noise information relates to a future time interval, wherein a length of the future time interval is based at least in part on a correlation time associated with the UE.

9. The apparatus of claim 1, wherein the plurality of bandwidth regions are bandwidth regions of a cell.

10. An apparatus for wireless communication at a network node, comprising:
one or more memories; and
one or more processors, coupled to the one or more memories, configured to cause the network node to:
receive information indicating predicted noise information associated with a plurality of bandwidth regions of a cell;
transmit a communication configuration associated with the plurality of bandwidth regions; and
perform a communication in accordance with the communication configuration.

11. The apparatus of claim 10, wherein the predicted noise information includes a plurality of respective predicted noise values corresponding to the plurality of bandwidth regions.

12. The apparatus of claim 11, wherein each predicted noise value of the respective predicted noise values corresponds to a different bandwidth region of the plurality of bandwidth regions.

13. The apparatus of claim 10, wherein the communication configuration indicates a first modulation order for a first bandwidth region of the plurality of bandwidth regions and a second modulation order, different from the first modulation order, for a second bandwidth region of the plurality of bandwidth regions.

14. The apparatus of claim 13, wherein the first modulation order is based at least in part on a predicted noise value, of the predicted noise information, corresponding to the first bandwidth region.

15. The apparatus of claim 10, wherein the information indicating the predicted noise information is based at least in part on a noise spectrum measurement.

16. The apparatus of claim 10, wherein the predicted noise information is based at least in part on at least one of a thermal noise value or a cross-cell interference value.

17. The apparatus of claim 10, wherein the predicted noise information is based at least in part on an autocovariance function.

18. The apparatus of claim 10, wherein the predicted noise information is based at least in part on an autoregressive-moving-average model.

19. The apparatus of claim 10, wherein the predicted noise information is based at least in part on a machine learning model.

20. The apparatus of claim 10, wherein the predicted noise information relates to a future time interval, wherein a length of the future time interval is based at least in part on a correlation time.

21. A method of wireless communication performed by a user equipment (UE), comprising:
transmitting information indicating predicted noise information associated with a plurality of bandwidth regions;
receiving a communication configuration associated with the plurality of bandwidth regions; and
performing a communication in accordance with the communication configuration.

22. The method of claim 21, wherein the predicted noise information includes a plurality of respective predicted noise values corresponding to the plurality of bandwidth regions.

23. The method of claim 22, wherein each predicted noise value of the respective predicted noise values corresponds to a different bandwidth region of the plurality of bandwidth regions.

24. The method of claim 21, wherein the communication configuration indicates a first modulation order for a first bandwidth region of the plurality of bandwidth regions and a second modulation order, different from the first modulation order, for a second bandwidth region of the plurality of bandwidth regions.

25. A method of wireless communication performed by a network node, comprising:
receiving information indicating predicted noise information associated with a plurality of bandwidth regions of a cell;
transmitting a communication configuration associated with the plurality of bandwidth regions; and
performing a communication in accordance with the communication configuration.

26. The method of claim 25, wherein the predicted noise information includes a plurality of respective predicted noise values corresponding to the plurality of bandwidth regions.

27. The method of claim 26, wherein each predicted noise value of the respective predicted noise values corresponds to a different bandwidth region of the plurality of bandwidth regions.

28. The method of claim 25, wherein the communication configuration indicates a first modulation order for a first bandwidth region of the plurality of bandwidth regions and a second modulation order, different from the first modulation order, for a second bandwidth region of the plurality of bandwidth regions.

29. The method of claim 28, wherein the first modulation order is based at least in part on a predicted noise value, of the predicted noise information, corresponding to the first bandwidth region.

30. The method of claim 25, wherein the information indicating the predicted noise information is based at least in part on a noise spectrum measurement.
